(19) United States
(12) Patent Application Publication
(10) Pub. No.: US 2012/0314929 A1
(43) Pub. Date: Dec. 13, 2012

(54) SYSTEM AND METHOD FOR AUTOMATIC GENERATION OF STRUCTURE DATASETS

(76) Inventor: Thomas Boettger, Heidelberg (DE)

(21) Appl. No.: 13/324,899

(22) Filed: Dec. 13, 2011

(30) Foreign Application Priority Data
Dec. 20, 2010 (DE) DE102010063551.0

(51) Int. Cl. G06K 9/34

(52) U.S. Cl. 382/132

(57) ABSTRACT

The present embodiments relate to a system for automatic generation of structure datasets that are used for planning radiotherapy. The system includes a receiver unit that receives an image dataset of a person being examined. A central segmentation unit is provided. The receiver unit forwards the image dataset automatically to the central segmentation unit, the central segmentation unit having an identification unit for identifying a region of the body and a plurality of segmentation modules. Each segmentation module of the plurality of segmentation modules segments the image dataset using different segmentation methods. The identification unit, following identification of the region of the body, selects a segmentation module on the basis of the region of the body identified and automatically forwards the image dataset to the selected segmentation module. The selected segmentation module segments the image dataset, identifies predetermined structures in the image dataset, and generates a structure dataset.

This application claims the benefit of DE 10 2010 063 551.0, filed on Dec. 20, 2010.

### BACKGROUND

The present embodiments relate to automatic generation of structure datasets as are used for planning radiotherapy.

The procedure when planning radiotherapy for a person being examined is to record and archive image datasets of the person being examined. If the physician plans the radiotherapy, structures that should be as little damaged as possible during the radiotherapy are identified on the image datasets. The physician analyzes the recorded image data and in the image data, identifies organs such as, for example, a liver, a kidney or bone. If organs at risk or objects to be protected surrounding the tumor to be irradiated are identified, a start may be made on planning the radiotherapy. However, the identification of the individual structures in the image dataset may be very time-consuming.

### SUMMARY AND DESCRIPTION

The present embodiments may obviate one or more of the drawbacks or limitations in the related art. For example, the generation of a structure dataset, as is used for planning radiotherapy, may be accelerated and improved.

In a first embodiment, a system is provided for automatic generation of structure datasets that are used for planning radiotherapy. The system has a receiver unit that receives an image dataset of a person being examined. A central segmentation unit is also provided. The receiver unit automatically forwards the image dataset to the central segmentation unit. The central segmentation unit has an identification unit for identifying the regions of the body and a plurality of segmentation modules. Each segmentation module of the plurality of segmentation module segments the image dataset using different segmentation methods. Once the identification unit identifies the regions of the body, the identification unit selects a segmentation module on the basis of the region of the body identified and automatically forwards the image dataset to the selected segmentation module. The selected segmentation module segments the image dataset and identifies predetermined structures in the image dataset. The selected segmentation module generates a structure dataset that is automatically saved in a data memory of the system.

A central segmentation unit is provided, to which the image datasets are transferred. The segmentation unit may initially identify the region of the body and select one segmentation module of a plurality of segmentation modules. Each segmentation module of the plurality of segmentation modules is especially suitable for segmenting a particular area of the body or for identifying particular organs. As a result, the structure dataset may be generated and saved in a simple and efficient manner. By using a central segmentation unit, many different and also very complex segmentation algorithms may be used, which improve and accelerate the segmentation. The physician need only retrieve the generated structure dataset and possibly briefly check the identified structures, and may then immediately start planning the radiotherapy.

Each segmentation module of the plurality of segmentation modules is optimized in order to recognize predetermined structures in the image dataset. Depending on the region of the body examined, various structures that are differently embedded in the surrounding tissue or bones are to be recognized. Some segmentation algorithms are better at recognizing sharp edges, while other algorithms, for example, work on the basis of regions and are suitable for recognizing homogeneous image areas. By selecting the segmentation module on the basis of the region of the body to be segmented, the segmentation method best suited for the region of the body and the organs contained in the region of the body may be used. Such combinations of algorithms may be preconfigured and parameterized using presets.

In one embodiment, the structure dataset is a DICOM radiotherapy structure dataset (DICOM-RT structure dataset).

The present embodiments also relate to a method for automatic generation of the structure datasets, the recorded image dataset automatically being transferred to the central segmentation unit in a first act. A region of the body that is represented in the image dataset is automatically identified. In a next act, a segmentation module is automatically selected from a plurality of segmentation modules in the central segmentation unit on the basis of the region of the body identified. The segmentation modules each segment the image dataset using different segmentation methods. In a further act of the method, the image dataset is automatically transferred to the selected segmentation module, and the selected segmentation module automatically segments the image dataset received in order to identify predetermined structures in the image dataset for the generation of the structure dataset. In a further act, the generated structure dataset is stored in a data memory.

Organ edges may be determined in the image dataset during the automatic segmentation, and the organs mapped in the image dataset are identified, so that an organ-specific structure dataset may be generated and saved.

### BRIEF DESCRIPTION OF THE DRAWINGS

FIG. 1 illustrates, schematically, an example system for fully automatic generation of a structure dataset; and

FIG. 2 is a flow chart containing the acts for the fully automatic generation of a structure dataset, according to one embodiment.

### DETAILED DESCRIPTION OF THE DRAWINGS

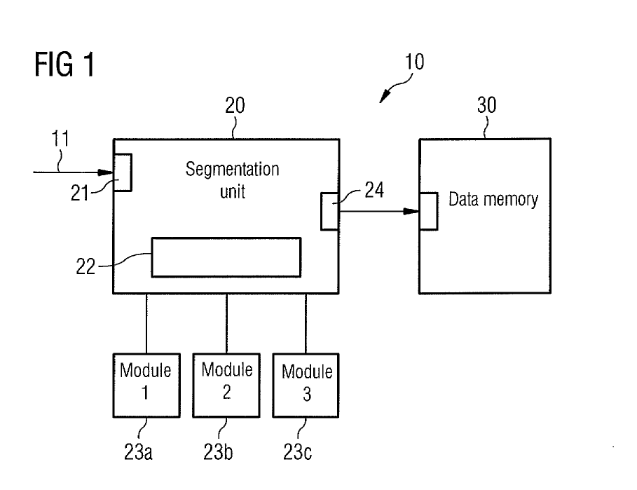

FIG. 1 schematically shows a system for automatically generating a structure dataset 10. Image datasets are fed to the system via an interface, as symbolized by arrow 11. The image datasets fed may be datasets that may be generated using a computed tomography (CT) system, a magnetic resonance tomography (MRT) system, or a positron emission tomography (PET) system. The image dataset may consist of ultrasound images or of a combination of the imaging systems listed above. The system has a central segmentation unit 20 with a receiver unit 21, in which the image data is received. The receiver unit 21 automatically forwards the image data received to an identification unit 22 for identification of a region of a body shown in the image dataset. The central segmentation unit 20 is connected to a plurality of segmentation modules 23a, 23b, 23c. Each segmentation module of the plurality of segmentation modules 23a, 23b, 23c works with a different segmentation algorithm. For example, the first module 23a may work with a segmentation algorithm that is well suited for showing bones, whereas the second segmentation module 23b is well suited for showing organs (e.g., the liver or the kidney). Each segmentation module of the plurality of segmentation modules 23a, 23b, 23c is suitable for the segmentation of image data of a particular region of the body. Once the identification unit 22 has approximately identified the region of the body shown in the image dataset, the identification unit 22 decides to which segmentation module of the plurality of segmentation modules 23a, 23b, 23c to forward the image dataset in order to perform the actual segmentation to determine the structures shown in the image dataset. Once the selected segmentation module has segmented the image dataset and predetermined structures have been recognized in the image dataset, the structured data may automatically be forwarded via an output unit 24 to a memory unit 30, where the structure datasets are stored. A physician retrieves the structure datasets contained in the memory unit 30 in order to be able to start the actual planning of the radiotherapy.

Units shown in FIG. 1 (e.g., functional unit such as the identification unit 22 and the plurality of segmentation modules 23a-23c) are shown as separate units. However, the functional units do not have to be configured as separate units. The tasks shown in the functional units may also be performed by a single unit. The units shown may be implemented by software (e.g., instructions stored on a non-transitory computer readable storage medium for execution by a processor) or hardware or a combination of software and hardware.

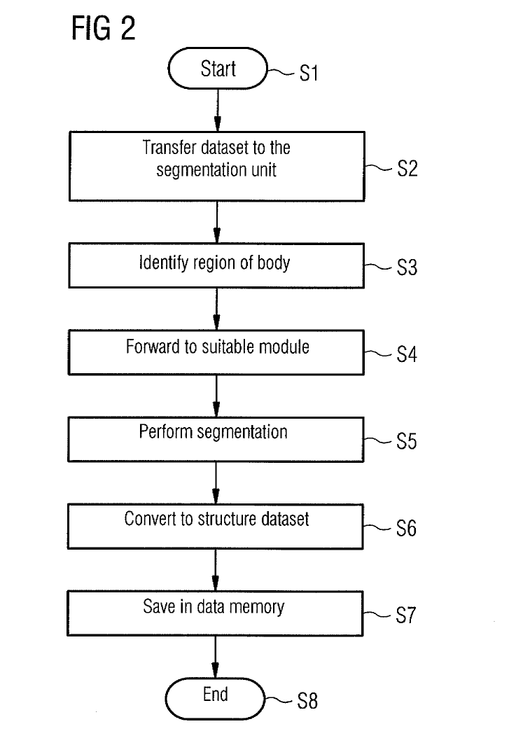

FIG. 2 summarizes the acts for automatic generation of a structure dataset. After the method is launched in act S1, generated image data (e.g., an image dataset) is automatically transferred to a segmentation unit in act S2. In act S3, an area of a body, from which the image dataset was recorded, is automatically identified. The identified area of the body may, for example, be an area such as an upper part of the body, legs, arms or a head. Once the area of the body shown is identified in act S3, the image dataset, in act S4, is forwarded to a segmentation module that is suitable for the segmentation of the identified area of the body. In act S5, the segmentation is performed in the selected segmentation module. Contours within the image dataset are generated in act S5. By comparing the contours with known structures in atlases, the organ mapped in the image dataset may, for example, be identified. Following identification of the organ or organs shown, the image dataset is converted into a structure dataset (act S6) that contains the contours, as segmented. The contoured dataset or structure dataset may be saved in act S7. The method ends in act S8.

The image dataset may also be a combined dataset, in which CT, MR, PET and ultrasound images are combined. The structure datasets may also contain points of interest (POIs). The points of interest are, for example, points for planning radiotherapy. If the segmentation module is unable to segment organ boundaries, the segmentation module may at least draw in a center point of the organ or an approximate box around the organ. Since the generated image data is automatically fed to the system for generation of the structure datasets, there is more time for generating the structure datasets, and more complex segmentation algorithms may be used. The physician no longer has to trigger or perform the segmentation himself or herself. This represents a very large time gain, and the generation of the structure dataset is improved, since more complex algorithms may be used by using the central segmentation unit.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for the automatic generation of structure datasets that are used for planning radiotherapy, the system comprising:
a receiver unit operable to receive an image dataset of a person being examined;
a central segmentation unit, the receiver unit operable to automatically provide the image dataset to the central segmentation unit, the central segmentation unit having an identification unit configured for identifying a region of the body of the patient and a plurality of segmentation modules, each segmentation module of the plurality of segmentation modules operable to segment the image dataset using different segmentation methods, the identification unit being configured, following identification of the region of the body, to select a segmentation module of the plurality of segmentation modules on the basis of the region of the body identified and to provide the image dataset automatically to the selected segmentation module, the selected segmentation module automatically segmenting the image dataset, identifying predetermined structures in the image dataset, and generating a structure dataset; and
a data memory operable to automatically store the generated structure dataset.

2. The system as claimed in claim 1, wherein each segmentation module of the plurality of segmentation modules is optimized to identify the predetermined structures in the image dataset.

3. The system as claimed in claim 1, wherein the structure dataset is a DICOM radiotherapy structure dataset.

4. The system as claimed in claim 2, wherein the structure dataset is a DICOM radiotherapy structure dataset.

5. A method for automatic generation of structure datasets that are used for radiotherapy, the method comprising:
automatically transferring an image dataset of a person being examined to a central segmentation unit;
automatically identifying a region of the body of the person that is shown in the image dataset;
automatically selecting a segmentation module from a plurality of segmentation modules in a central segmentation unit on the basis of the region of the body identified, each segmentation module of the plurality of segmentation modules segmenting the image dataset using different segmentation methods;
automatically transferring the image dataset to the selected segmentation module;
automatically segmenting the image dataset by the selected segmentation module to identify predetermined structures for generating a structure dataset; and
automatically storage of the generated structure dataset in a data memory.

6. The method as claimed in claim 5, further comprising generating and storing a DICOM radiotherapy structure dataset.

7. The method as claimed in claim 5, wherein during the automatic segmentation, edges of organs are determined in the image dataset, and organs mapped in the image dataset are identified, the generated structure dataset being an organ-specific structure dataset.

8. The method as claimed in claim 6, wherein during the automatic segmentation, edges of organs are determined in the image dataset, and organs mapped in the image dataset are identified, the generated structure dataset being an organ-specific structure dataset.
